(19) United States
(12) Patent Application Publication
(10) Pub. No.: US 2012/0081069 A1
(43) Pub. Date: Apr. 5, 2012

(54) COMMUNICATION APPARATUS AND SIGNAL PROCESSING METHOD

(75) Inventor: Johnny Chen, Santa Ana, CA (US)

(73) Assignee: I O INTERCONNECT, LTD., Santa Ana, CA (US)

(21) Appl. No.: 13/007,657

(22) Filed: Jan. 16, 2011

Related U.S. Application Data
(60) Provisional application No. 61/388,587, filed on Sep. 30, 2010.

(51) Int. Cl. H02J 7/00

(52) U.S. Cl. 320/108

(57) ABSTRACT

A communication apparatus for a portable electronic device. The communication apparatus includes a charging module, a transceiver module and a signal repeating unit. The charging module provides a charging function in a wired or wireless manner to charge up the portable electronic device. The transceiver module receives signals from the portable electronic device and transmits enhanced signals to an air interface. The signal repeating unit receives the signals and enhances the signals to generate the enhanced signals.

### CROSS REFERENCE TO RELATED APPLICATIONS

This application claims the benefit of U.S. Provisional Application No. 61/388,587 filed 2010 Sep. 30 and entitled “Communication Apparatus and Signal and/or Data Transmission Method”. The entire contents of which are hereby incorporated by reference.

### BACKGROUND OF THE INVENTION

1. Field of the Invention

The invention relates to a communication apparatus, and more particularly to a communication apparatus provided with at least a charging function and a signal repeating function.

2. Description of the Related Art

Portable electronic devices, such as portable personal communication devices and portable tablet personal computers, are very popular currently, since they provide users with convenient voice communications and network access functions.

Therefore, any new features to expand the functionality and increase the attraction of a portable electronic device are eagerly sought out and developed.

### BRIEF SUMMARY OF THE INVENTION

A communication apparatus and signal processing method for processing signals of a portable electronic device are provided. An exemplary embodiment of a communication apparatus for a portable electronic device comprises a charging module, a transceiver module and a signal repeating unit. The charging module provides a charging function in a wired or wireless manner to charge the portable electronic device. The transceiver module receives a plurality of signals from the portable electronic device and transmits a plurality of enhanced signals to an air interface. The signal repeating unit receives the signals and enhances the signals to generate the enhanced signals.

Another exemplary embodiment of a signal processing method for processing a plurality of signals of a portable electronic device comprises: providing a communication apparatus with at least a charging function and a signal repeating function; electrically connecting the portable electronic device to the communication apparatus; extracting the signals from the portable electronic device and transmitting the signals to the communication apparatus; enhancing the signals to generate a plurality of enhanced signals by the communication apparatus; and transmitting the enhanced signals to an air interface by the communication apparatus.

Another exemplary embodiment of a communication apparatus capable of providing a charging function for a portable electronic device comprises a connection interface, a charging module, a transceiver module and a signal repeating unit. The connection interface is coupled in a wired or wireless manner to the portable electronic device. The charging module provides a charging function through the connection interface to charge up the portable electronic device. The transceiver module receives a plurality of signals from the portable electronic device and transmitting a plurality of enhanced signals to an air interface through the connection interface. The signal repeating unit receives the signals and enhancing the signals to generate the enhanced signals.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic block diagram of a communication apparatus according to an embodiment of the invention;

FIG. 2 a schematic diagram of an exemplary communication system according to an embodiment of the invention;

FIG. 3 shows another schematic diagram of a communication system according to another embodiment of the invention; and

FIG. 4 shows a flow chart of a signal processing method for processing a plurality of signals of a portable electronic device according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

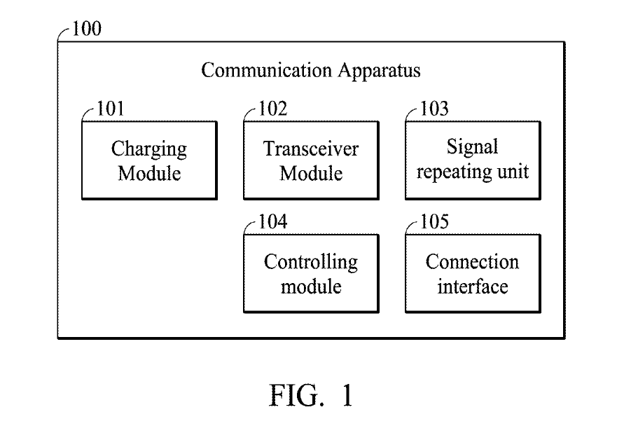

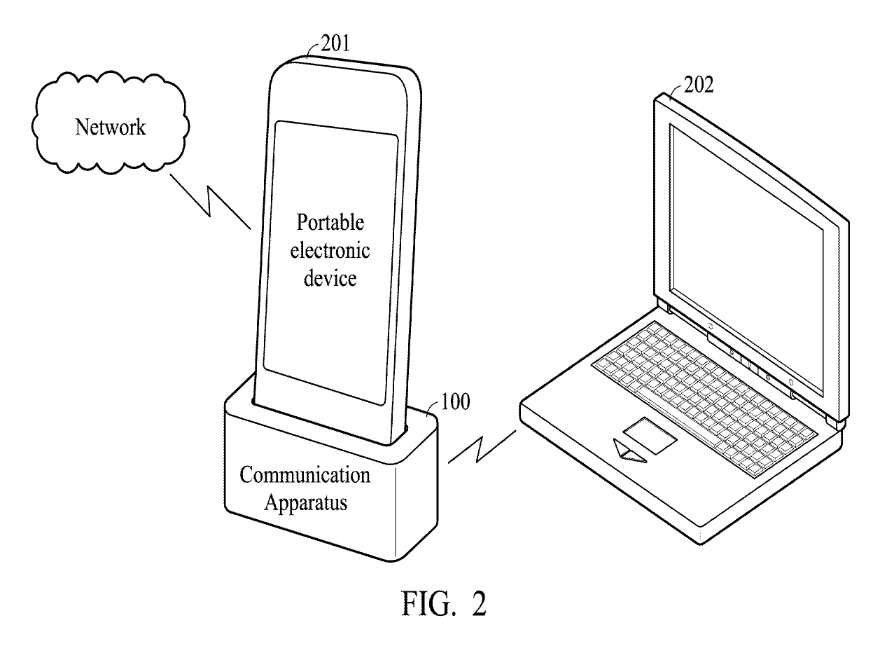

FIG. 1 shows a schematic block diagram of a communication apparatus according to an embodiment of the invention. The communication apparatus 100 may at least comprise a charging module 101, a transceiver module 102 and a signal repeating unit 103. The charging module 101 is arranged to provide a charging function to charge up a portable electronic device (such as the portable electronic device 201 shown in FIG. 2). The transceiver module 102 is arranged to receive a plurality of signals from the portable electronic device and transmit a plurality of enhanced signals to an air interface. The signal repeating unit 103 is arranged to receive the signals and enhance the signals to generate the enhanced signals. In one embodiment of the invention, the signal repeating unit 103 may comprise a power amplifier to enhance level or power of the signals. Note that the signal repeating unit 103 may directly receive the signals from the portable electronic device 201, or receive the signals of the portable electronic device 201 from the transceiver module 102, and the invention should not be limited thereto. In addition, in some embodiments of the invention, the signal repeating unit 103 may also be comprised by the transceiver module 102, and the invention should not be limited thereto.

According to an embodiment of the invention, the communication apparatus 100 may be a charging dock capable of providing a charging function for portable electronic devices. One or more electronic devices may be electrically connected to the communication apparatus for battery charging. The charging module 101 may receive electric power from a power source and use the electric power to charge up the portable electronic devices. Note that the electric connection may be presented in either a wired or wireless manner, and the invention should not be limited to either case. For example, in one embodiment of the invention, the communication apparatus 100 may be connected to the portable electronic device via a connection interface 105 as shown in FIG. 1, so as to provide the electric power through the connection interface 105 to charge up the portable electronic device. Note that the connection interface may be implemented as a tangible connector to directly connect to the portable electronic devices. However, the connection interface may also be implemented as a communication interface facilitating a wireless connection established between the communication apparatus and the portable electronic devices. Therefore, the charging module 101 may directly charge up the portable electronic device or wirelessly charge up the portable electronic device through the air interface and the invention should not be limited to either cases.

FIG. 2 shows a schematic diagram of an exemplary communication system according to an embodiment of the invention. Note that the drawings illustrate the communication apparatus with a portable electronic device and a computer. However, the present innovation should not be limited thereto. When a portable electronic device 201 (or multiple portable electronic devices, and the present innovation is not limited thereto) is electrically connected to the communication apparatus 100, the communication apparatus 100 may act as a repeater to receive signals from the portable electronic device 201, enhance the signals and transmit the enhanced signals to the air interface. According to an embodiment of the invention, the signals may be transmitted from the portable electronic device 201 to the communication apparatus 100 via the electric connection therebetween. The electric connection may be presented in either a wired or wireless manner, and the invention should not be limited thereto. For example, the signals may be transmitted from the portable electronic device 201 to the communication apparatus 100 via the wire or the pins of a connector connected therebetween, or may be wirelessly transmitted from the portable electronic device 201 to the communication apparatus 100.

According to an embodiment of the invention, the portable electronic device 201 may be equipped with a predetermined communication module to provide a predetermined wireless communications service in compliance with a predetermined protocol. When the communication apparatus 100 is electrically connected to (either in a wired or a wireless manner) the portable electronic device 201, a new function of providing network access services, such as being like a hotspot or access point, may be achieved. A peer electronic device 202, such as a notebook shown in FIG. 2, may establish a wireless connection with the portable electronic device 201. For example, the transceiver module 102 may transmit the enhanced signals to the peer electronic device 202 through the air interface so as to facilitate a wireless connection established between the portable electronic device 201 and the peer electronic device 202. Having the wireless connection established therebetween, the communication apparatus 100 and the portable electronic device 201 may further act as a hotspot (or so-called access point) to facilitate the peer electronic device 202 to connect to an internet therethrough.

For example, when the portable electronic device 201 is equipped with a WiFi communication module, the WiFi signals generated by the portable electronic device 201 for providing communication service and/or Network access function may be passed to the communication apparatus 100, repeated and then transmitted by the communication apparatus 100 to the air interface. The peer electronic device 202 may receive the WiFi signals transmitted by the communication apparatus 100 from the air interface, and use the communication service and/or connect to the Network via the portable electronic device 201 and the communication apparatus 100.

For another example, when the portable electronic device 201 is equipped with a UMTS communication module, the 3G signals generated by the portable electronic device 201 for providing a communication service and/or Network access function may be passed to the communication apparatus 100, repeated and then transmitted by the communication apparatus 100 to the air interface. The peer electronic device 202 may receive the 3G signals from the air interface, and use the communication service and/or connect to the Network via the portable electronic device 201 and the communication apparatus 100.

Note that in the embodiments of the invention, even if the portable electronic device 201 is not charged by the communication apparatus 100, as long as the portable electronic device 201 is electrically connected to the communication apparatus 100, the signals may be transmitted therebetween. In other words, the communication apparatus 100 and the portable electronic device 201 may act as a hotspot or an access point regardless of whether the portable electronic device 201 is being charged by the communication apparatus 100.

According to an embodiment of the invention, the communication apparatus 100 may further comprise a controlling module 104 as shown in FIG. 1 for controlling the signal received from and/or transmitted to the portable electronic device. The controlling module 104 may be a controller chip controlling the transceiver module to extract the signals from the portable electronic device 201, and/or direct the signals received from the air interface to the portable electronic device 201. Note also that according to yet another embodiment of the invention, the controlling module 104 may also be implemented in the side of the portable electronic device and the innovation should not be limited thereto. For example, the controlling module may be as a software application function installed therein for controlling the signals to be transmitted to and/or received from the communication apparatus 100.

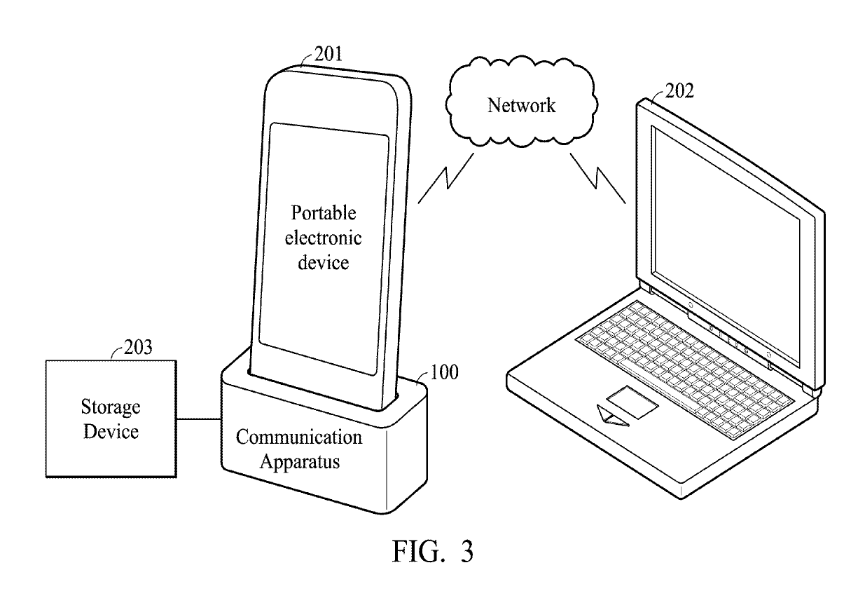

FIG. 3 shows another schematic diagram of a communication system according to another embodiment of the invention. In the aspect of the invention, the communication apparatus 100 may further be electrically connected to a storage device 203, and integrated with the storage device 203 as a NAS (network attached storage) system. Network attached storage (NAS) is a file-level data storage device connected to a Network for providing data access to heterogeneous clients. According to an embodiment of the invention, the communication apparatus 100 may be equipped with a connector, such as a USB port, to electrically connect to the storage device 203. Because, as previously described, the communication apparatus 100 may act as a repeater or hotspot, along with the portable electronic device 201 to provide communication service and/or Network access function, the communication apparatus 100 may further be a NAS when a storage device 203 is electrically connected thereto.

A peer electronic device 202, such as a notebook shown in FIG. 3, that is connecting to the Network and using the communication service 100 via the portable electronic device 201, may further access the data stored in the storage device 203. For example, the peer electronic device 202 may issue a data access request for wireless access of data through the communication apparatus 100. The transceiver module 102 may transmit the data stored in the storage device 203 to the air interface in response to the data access request received from the portable electronic device 201, which has a wireless connection with the peer electronic device 202 as previously described. Note that in some embodiments, the data access request may be transmitted from the peer electronic device 203 to the portable electronic device 202, or directly to the communication apparatus 100, and the invention should not be limited thereto. Note also that in some embodiments, the storage device may also be a built-in storage device inside of the communication apparatus 100, and the invention should not be limited thereto.

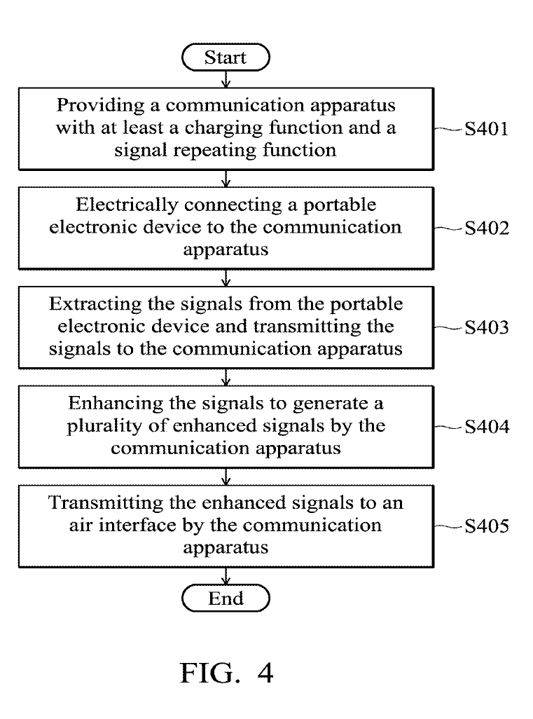

FIG. 4 shows a flow chart of a signal processing method for processing a plurality of signals of a portable electronic device according to an embodiment of the invention. A communication apparatus with at least a charging function and a signal repeating function is first provided (Step S401). Next, the portable electronic device is electrically connected to the communication apparatus (Step S402). Next, the signals are extracted from the portable electronic device and transmitted to the communication apparatus (Step S403). Next, the signals are enhanced to generate enhanced signals by the communication apparatus (Step S404). Finally the enhanced signals are transmitted to an air interface by the communication apparatus (Step S405), so as to facilitate a wireless connection established between the portable electronic device and a peer electronic device.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communication apparatus for a portable electronic device, comprising:
a charging module, providing a charging function in a wired or wireless manner to charge up the portable electronic device;
a transceiver module, receiving a plurality of signals from the portable electronic device and transmitting a plurality of enhanced signals to an air interface; and
a signal repeating unit, receiving the signals and enhancing the signals to generate the enhanced signals.

2. The communication apparatus as claimed in claim 1, further comprising:
a connection interface, connecting the charging module to the portable electronic device,
wherein through the connection interface, the charging module provides the charging function to charge up the portable electronic device and the transceiver module receives the signals from the portable electronic device.

3. The communication apparatus as claimed in claim 1, wherein the signal repeating unit comprises a power amplifier.

4. The communication apparatus as claimed in claim 1, further comprising:
a controlling module, controlling the transceiver module to extract the signals from the portable electronic device.

5. The communication apparatus as claimed in claim 1, wherein the transceiver module further transmits the enhanced signals to a peer electronic device through the air interface so as to facilitate a wireless connection established between the portable electronic device and the peer electronic device.

6. The communication apparatus as claimed in claim 1, further comprising:
a storage device, for storing data,
wherein the transceiver module transmits the data stored in the storage device to the air interface in response to a data assess request received from the portable electronic device.

7. The communication apparatus as claimed in claim 6, wherein the data assess request is received from a peer electronic device having a wireless connection with the portable electronic device.

8. A signal processing method for processing a plurality of signals of a portable electronic device, comprising:
providing a communication apparatus with at least a charging function and a signal repeating function;
electrically connecting the portable electronic device to the communication apparatus;
extracting the signals from the portable electronic device and transmitting the signals to the communication apparatus;
enhancing the signals to generate a plurality of enhanced signals by the communication apparatus; and
transmitting the enhanced signals to an air interface by the communication apparatus.

9. The method as claimed in claim 8, further comprising:
providing electric power to the portable electronic device to charge up the portable electronic device by the communication apparatus.

10. The method as claimed in claim 8, further comprising:
amplifying the signals to generate the enhanced signals.

11. The method as claimed in claim 8, further comprising:
establishing a wireless connection between the portable electronic device and a peer electronic device by using the enhanced signals.

12. The method as claimed in claim 11, further comprising:
facilitating the peer electronic device to connect to an internet through the portable electronic device by the communication apparatus.

13. The method as claimed in claim 11, further comprising:
providing a storage device electrically connected to the communication apparatus for storing data; and
issuing a data assess request for wirelessly accessing the data through the communication apparatus.

14. The method as claimed in claim 13, further comprising:
receiving the data assess request from the portable electronic device by the communication apparatus;
access the data by the communication apparatus; and
transmitting the accessed data to the air interface in response to the data assess request by the communication apparatus.

15. The method as claimed in claim 14, wherein the data assess request is issued by the peer electronic device and transmitted from the peer electronic device to the portable electronic device.

16. A communication apparatus capable of providing a charging function for a portable electronic device, comprising:
a connection interface, coupled in a wired or wireless manner to the portable electronic device,
a charging module, providing a charging function through the connection interface to charge up the portable electronic device;
a transceiver module, receiving a plurality of signals from the portable electronic device and transmitting a plurality of enhanced signals to an air interface through the connection interface; and
a signal repeating unit, receiving the signals and enhancing the signals to generate the enhanced signals.

17. The communication apparatus as claimed in claim 16, further comprising:
a controlling module, controlling the transceiver module to extract the signals from the portable electronic device.

18. The communication apparatus as claimed in claim 16, wherein the transceiver module further transmits the enhanced signals to a peer electronic device through the air interface so as to facilitate a wireless connection established between the portable electronic device and the peer electronic device.

19. The communication apparatus as claimed in claim 16, further comprising:
a storage device, for storing data,
wherein the transceiver module transmits the data stored in the storage device to the air interface in response to a data assess request received from the portable electronic device.

20. The communication apparatus as claimed in claim 19, wherein the data assess request is received from a peer electronic device having a wireless connection with the portable electronic device.
